(19) United States
(12) Patent Application Publication
(10) Pub. No.: US 2016/0167979 A1
(43) Pub. Date: Jun. 16, 2016

(54) METHOD FOR MAKING SPHERICAL COBALT OXYHYDROXIDE

(71) Applicants: Jiangsu Huadong Institute of Li-ion Battery Co. Ltd., Zhangjiagang (CN); Tsinghua University, Beijing (CN)

(72) Inventors: MOU FANG, Beijing (CN); YAO-WU WANG, Beijing (CN); XIANG-MING HE, Beijing (CN); LI WANG, Beijing (CN); YU-MING SHANG, Beijing (CN); JIAN GAO, Beijing (CN); JIAN-WEI GUO, Beijing (CN); ZONG-QIANG MAO, Beijing (CN)

(21) Appl. No.: 15/053,330

(22) Filed: Feb. 25, 2016

Related U.S. Application Data
(63) Continuation of application No. PCT/CN2014/084723, filed on Aug. 19, 2014.

(30) Foreign Application Priority Data
Aug. 27, 2013 (CN) 201310378777.7

(51) Int. Cl. C01G 51/04; H01M 10/0525; H01M 4/48

(52) U.S. Cl. CPC C01G 51/04; H01M 4/48; H01M 10/0525; C01P 2004/32; H01M 2220/30

(57) ABSTRACT

A method for making a spherical cobalt oxyhydroxide requires a controlled crystallization reactor. A buffer agent is put into the controlled crystallization reactor. The buffer agent is capable of controlling a reacting speed of reactants. A cobalt salt solution and an alkaline solution as the reactants are added into the buffer agent in the controlled crystallization reactor. The reactants react together in a controlled crystallization method, the reactants being agitated only at a bottom region of the container of the controlled crystallization reactor.

### CROSS-REFERENCE TO RELATED APPLICATIONS

This application claims all benefits accruing under 35 U.S.C. §119 from China Patent Applications No. 201310378777.7, filed on Aug. 27, 2013 in the China Intellectual Property Office, the content of which is hereby incorporated by reference. This application is a continuation under 35 U.S.C. §120 of international patent application PCT/CN2014/084723 filed Aug. 19, 2014, the content of which is hereby incorporated by reference. This application is related to a commonly-assigned application entitled, “METHOD FOR MAKING LITHIUM COBALT OXIDE”, filed **** (Atty. Docket No. US52664).

### FIELD

The present disclosure relates to lithium ion batteries, and specifically relates to a method for making spherical cobalt oxyhydroxide.

### BACKGROUND

Some developments of portable electronic devices such as smart phones, tablets, laptops, and mobile tools are based on a development of technology of lithium ion rechargeable batteries. Small portable electronic devices have critical demands on the batteries for safety, thermal stability, cycling life, etc. For this reason, lithium cobalt oxide is irreplaceable as a cathode active material in the lithium ion battery at present and in a foreseeable future.

As a raw material for making the lithium cobalt oxide, which is the most widely used cathode active material, cobalt oxyhydroxide has a performance that directly affects the final performance of the lithium cobalt oxide. To control morphology of the cobalt oxyhydroxide, a conventional method is to form secondary particles from a cobalt oxyhydroxide slurry by spray drying. The formed secondary particles are constructed of small cobalt oxyhydroxide particles, however a mass of these has a loose structure, of which the particle size is difficult to be controlled. Further, the method for forming the secondary particles is complicated, and unable to meet an energy density need and a cost reduction requirement.

### BRIEF DESCRIPTION OF THE DRAWINGS

Implementations are described by way of example only with reference to the attached figures.

FIG. 1 is a flowchart of an embodiment of a method for making a spherical cobalt oxyhydroxide.

FIG. 2 is a schematic view of an embodiment of a controlled crystallization reactor used in the method for making the spherical cobalt oxyhydroxide.

FIG. 3 shows a scanning electron microscope (SEM) image of an embodiment of spherical cobalt oxyhydroxide.

FIG. 4 shows an X-ray diffraction (XRD) pattern of the embodiment of spherical cobalt oxyhydroxide.

FIG. 5 shows an SEM image of an embodiment of lithium cobalt oxide formed from the spherical cobalt oxyhydroxide.

FIG. 6 shows an XRD pattern of the embodiment of lithium cobalt oxide formed from the spherical cobalt oxyhydroxide.

FIG. 7 shows electrochemical performance of an embodiment of a lithium ion battery using the lithium cobalt oxide formed from the spherical cobalt oxyhydroxide.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

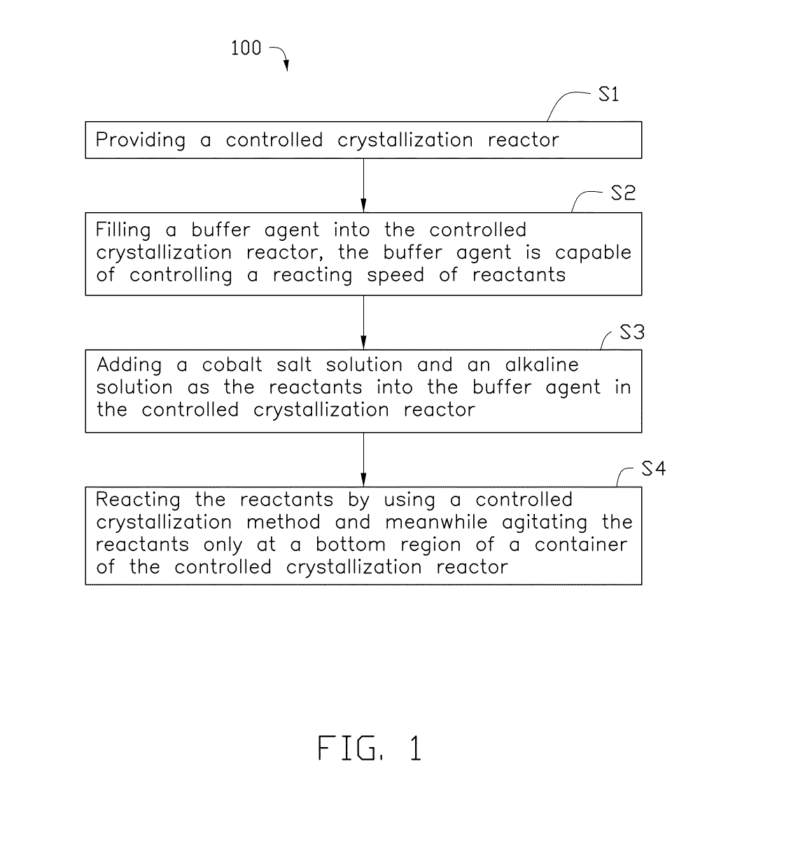

FIG. 1 presents a flowchart of an example method. This embodiment of a method 100 for making spherical cobalt oxyhydroxide is provided by way of example, as there are a variety of ways to carry out the method 100. Each block shown in FIG. 1 represents one or more processes, methods, or subroutines carried out in the exemplary method 100. Additionally, the illustrated order of blocks is by example only and the order of the blocks can be changed. The exemplary method 100 can begin at block S11. Depending on the embodiment, additional steps can be added, others removed, and the ordering of the steps can be changed.

The method 100 has a non-uniform agitation during the reacting of reactants in a controlled crystallization reactor which has a buffer agent, using a controlled crystallization method.

At block S1, a controlled crystallization reactor is provided.

At block S2, a buffer agent is filled into the controlled crystallization reactor. The buffer agent is used for controlling a reacting speed of reactants.

At block S3, a cobalt salt solution and an alkaline solution are used as the reactants that are filled into the buffer agent in the controlled crystallization reactor.

At block S4, the reactants react together, and meanwhile, the reactants are agitated only at a bottom region of the container of the controlled crystallization reactor. Accordingly, spherical cobalt oxyhydroxide is formed by a controlled crystallization method.

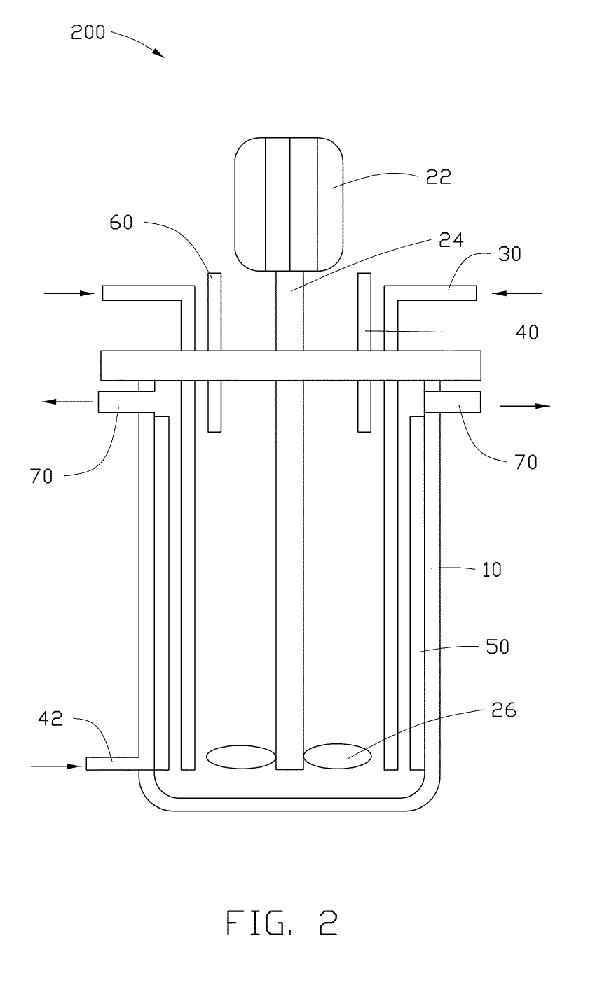

Referring to FIG. 2, the controlled crystallization reactor 100 comprises a container 10, an agitating device 20, and a feeding device.

The agitating device 20 is capable of agitating the reactants that are contained in the container 10. The agitating device comprises a motor 22, a shaft 24, and a paddle 26. The shaft 24 is connected to the motor 22. The paddle 26 is mounted on the shaft 24. In one embodiment, the paddle 26 is mounted only on an end of the shaft 24. The motor 22 is capable of driving the shaft 24 to rotate, and the rotating of the shaft 24 drives the paddle 26 to rotate. The end of the shaft 24 that has the paddle 26 mounted thereon is inserted in the container 10, and reaches a bottom region in the container 10. Thus, the paddle 26 only stirs at the bottom region in the container 10. Accordingly, the materials in the container 10 are agitated only at the bottom region of the container 10, and the non-uniform agitation of the materials in the container 10 leads to a non-uniform reaction. The agitating device 20 can comprise one or more paddles 26. The quantity of the paddles 26 can be decided according to a depth of the container 10. When the container 10 is relatively shallow, only one pair of paddles 26 can be set only at the end of the shaft 24. When the container 10 is relatively deep, a plurality of pairs of paddles 26 spaced from each other can be set at the end of the shaft 24. However, the paddles 26 are always located only at a bottom region in the container 10. In one embodiment, the bottom region can be defined from the surface of inner bottom of the container 10 to a level having 1/10˜⅓ depth of the container 10. By locating all paddles 26 in the bottom region, the non-uniform agitation can take place in the container 10.

The feeding device can comprise a plurality of inlet tubes 30, by which the different reactants and buffer agent are fed into the container 10 respectively. For example, the feeding device can comprise a cobalt salt solution inlet tube, an alkaline solution inlet tube, and a buffer agent inlet tube.

The controlled crystallization reactor 100 can further comprise a temperature controlling device to provide temperature control in the container 10. The temperature controlling device can comprise a heater and a thermometer 40. The heater can be disposed on an outer surface of a sidewall of the container 10. For example, the heater can be a water bath 42 as shown in FIG. 2 or resistance wires. The thermometer 40 can be inserted in the reactants in the container 10 to monitor the temperature of the reactants in the container 10.

The controlled crystallization reactor 100 can further comprise a baffle plate 50 located on an inner surface of the side wall of the container 10. The baffle plate 50 promotes the mixing of the reactants by blocking the materials during the agitating.

The controlled crystallization reactor 100 can further comprise a pH meter 60 to monitor the pH value in the container, thereby controlling the amount of the reactants.

The controlled crystallization reactor 100 can further comprise an overflow outlet 70 located at an upper side of the side wall of the container 10. The materials that reach the overflow outlet 70 during the agitating escape the container 10.

The spherical cobalt oxyhydroxide is formed during the non-uniform agitation of the reactants in the controlled crystallization reactor 100. The agitating of the reactants is only performed in the bottom region in the container 10. In one embodiment, the reactants are agitated only in a region up from the inner bottom of the container 10 to a level having 1/10˜⅓ depth of the container 10, and the level is measured from the inner bottom. A degree of filling up with the reactants in the container 10 can exceed the agitating region. In one embodiment, the reactants fill the container 10 up to more than ½ its depth. In another embodiment, the reactants fully fill the container 10 and reach the overflow outlet 70. During the agitating, any excess of reactants is expelled from the container 10 through the overflow outlet 70.

By stirring the reactants by the paddles 26 only in the bottom region of the container 10, the reacting product, i.e., the cobalt oxyhydroxide, in particle form, continuously collide with each other to form cobalt oxyhydroxide solid spheres having a regular spherical shape. Since the stirring of the paddles 26 only takes place in the bottom region in the container 10, the materials that are stirred have a tendency to rise up due to the centrifugal force formed by the rotating of the paddles 26, a rapid growth of the cobalt oxyhydroxide spheres caused by stirring at every region in the container 10 can be avoided, and the cobalt oxyhydroxide spheres move up and down repeatedly in the container 10 during the stirring, which results in greater forces in the collisions, to form dense and then denser spherical solid spheres made of the cobalt oxyhydroxide. When the formed spheres of cobalt oxyhydroxide have a sufficient diameter, they are thrown out from the container 10 through the overflow outlet 70, which ends the growing of the diameter. Thereby, the diameter of the spherical cobalt oxyhydroxide can be controlled.

A concentration of the buffer agent and a rotating speed of the paddles 26 can be controlled to control the reacting speed, by which regular cobalt oxyhydroxide solid spheres having a dense structure and a with controlled diameter can be formed during the non-uniform agitation.

The rotating speed of the paddles 26 can be in a range from 900 revolutions per minute (rpm) to 2000 rpm, which results a violent rotation. The concentration of the buffer agent in the controlled crystallization reactor 100 can be in a range from 3 mol/L to 8 mol/L. A diameter of the spherical cobalt oxyhydroxide can be in a range from 5 μm to 20 μm.

If the paddles 26 are uniformly located at every level of the container 10, a uniform agitation can take place in the container 10, during which the forces applied to the materials in the container 10 is weaker than those during non-uniform agitation. A test result shows that uniform agitation creates a majority of hollow spheres with diameters that are unable to be controlled. That is, the spheres grow to relatively large diameters, whereas the inside of the sphere is still loose and non-solid.

The reactants of the controlled crystallization reactor 100 can be further heated during the non-uniform agitation to have a reacting temperature in a range from 40° C. to 60° C.

The cobalt salt solution can be a water solution of a soluble cobalt salt. The cobalt salt can be selected from at least one of cobalt chloride, cobalt sulfate, and cobalt nitrate. The alkaline solution can be a strong alkaline solution, such as a water solution of potassium hydroxide, a water solution of sodium hydroxide, or a mixture thereof. In the controlled crystallization reactor 100, a molar ratio between the cobalt salt and the sodium hydroxide is about 12. The buffer agent can be selected from at least one of ammonium hydroxide, ethylenediamine tetraacetic acid (EDTA), and lactic acid. The buffer agent is added for controlling the reacting speed of the reactants.

The method for making the spherical cobalt oxyhydroxide can further comprise steps of:

preloading the buffer agent into the controlled crystallization reactor 100;

adding the cobalt salt solution and the strong alkaline solution simultaneously through their respective inlet tubes 30 into the buffer agent in the controlled crystallization reactor 100; and

non-uniform stirring the reactants in the controlled crystallization reactor 100.

The method for making the spherical cobalt oxyhydroxide is a continuous process, wherein after the buffer agent is filled into the controlled crystallization reactor 100, cobalt salt solution and alkaline solution are continuously added into the controlled crystallization reactor 100. The adding of the cobalt salt solution and the alkaline solution and the non-uniform agitating of the reactants in the controlled crystallization reactor 100 are continuously processed. By controlling the feeding speed of the cobalt salt solution and the alkaline solution, and by controlling the rotating speed of the paddles 26, the formed spherical cobalt oxyhydroxide continuously overflows through the overflow outlet, and the amount of the reactants in the controlled crystallization reactor 100 is maintained, thereby continuously forming the spherical cobalt oxyhydroxide. The feeding amount per minutes of the reactants can be in a range from 1/10000 to 1/300 of the volume of the container 10.

The cobalt salt solution and the alkaline solution can be fed slowly into the container 10 through two inlet tubes 30 by using peristaltic pumps. By controlling the feeding speed of the cobalt salt solution and the alkaline solution, the molar ratio between the cobalt salt and the sodium hydroxide is controlled to about 1:2 in the container 10. The pH value of the reactants in the container 10 is monitored. From the adding of the reactants to the overflowing of the spherical cobalt oxyhydroxide that is formed from the exact reactants, the materials remain for 5 hours to 72 hours in the container 10.

The spherical cobalt oxyhydroxide that overflows from the controlled crystallization reactor 100 can be further washed by deionized water.

The spherical cobalt oxyhydroxide can be used as a precursor to form lithium cobalt oxide. The spherical cobalt oxyhydroxide can be put into a lithium hydroxide solution to experience a hydrothermal reaction, during which the lithium in the lithium hydroxide replaces the hydrogen in the cobalt oxyhydroxide, to form spherical lithium cobalt oxide.

More specifically, the obtained spherical cobalt oxyhydroxide and lithium hydroxide solution can be mixed and filled into a hydrothermal reactor to undergo a hydrothermal reaction.

A concentration of the lithium hydroxide solution is not limited. In one embodiment, a saturated lithium hydroxide solution is used. In the hydrothermal reactor, a molar ratio between the cobalt oxyhydroxide and the lithium hydroxide can be smaller than 11. A reacting temperature of the hydrothermal reaction can be in a range from 150° C. to 200° C. A reacting time of the hydrothermal reaction can be 1 hour to 5 hours. A pressure in the hydrothermal reactor is self-generated, caused by the heating. Such pressure can be about 15 atms to about 22 atms, and preferably can be 18 atms. The hydrothermal reaction replaces the hydrogen in the spherical cobalt oxyhydroxide with lithium from the lithium hydroxide, during which the spherical shape of the cobalt oxyhydroxide is maintained, to form spherical lithium cobalt oxide. Additionally, after the hydrothermal reaction, the residual lithium hydroxide solution can be recycled.

The spherical lithium cobalt oxide formed by the hydrothermal reaction can be pumped out and vacuum dried, for example, at 50° C. to 90° C. for 5 hours to 10 hours.

The method for making the spherical lithium cobalt oxide can further comprise a step of sintering the obtained lithium cobalt oxide. The lithium cobalt oxide can be sintered in an oven at a temperature of 350° C. to 800° C. for 3 hours to 10 hours. The sintering step removes the water of crystallization or other impurities in the product of the hydrothermal reaction, and the crystallinity of the lithium cobalt oxide is increased. The sintering step can take place in the open air.

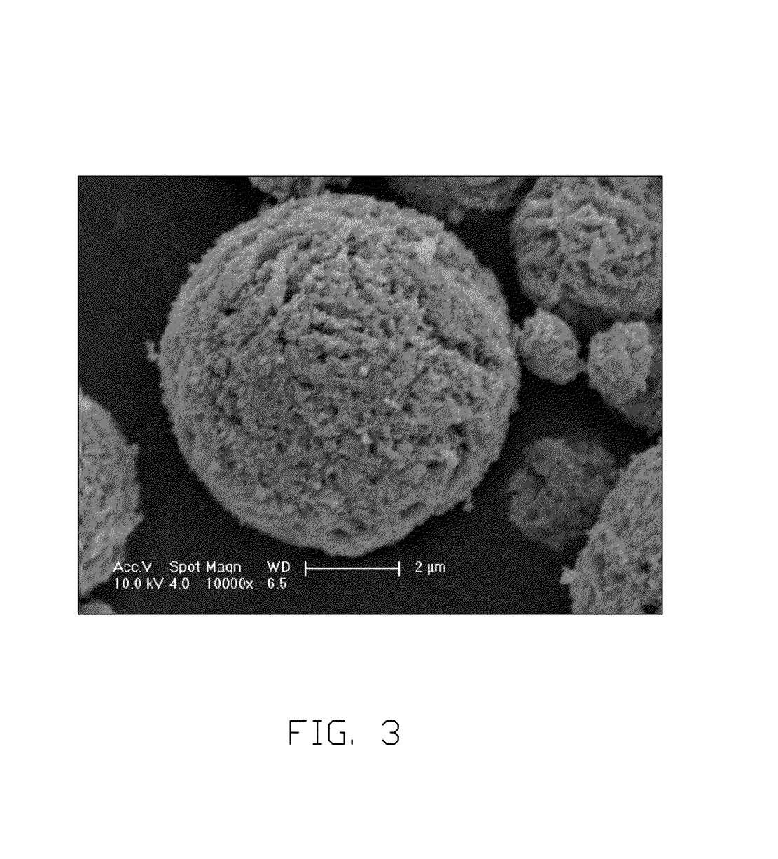

Referring to FIG. 3, the cobalt oxyhydroxide formed by the present method has a spherical shape. The spherical cobalt oxyhydroxide is a one-step formation, does not need to previously form initial powders of cobalt oxyhydroxide and further build secondary balls by aggregating the initial powders through processes such as prilling and riddling. The spherical cobalt oxyhydroxide obtained from the present method has a dense structure, an ordered shape, and a high tap density.

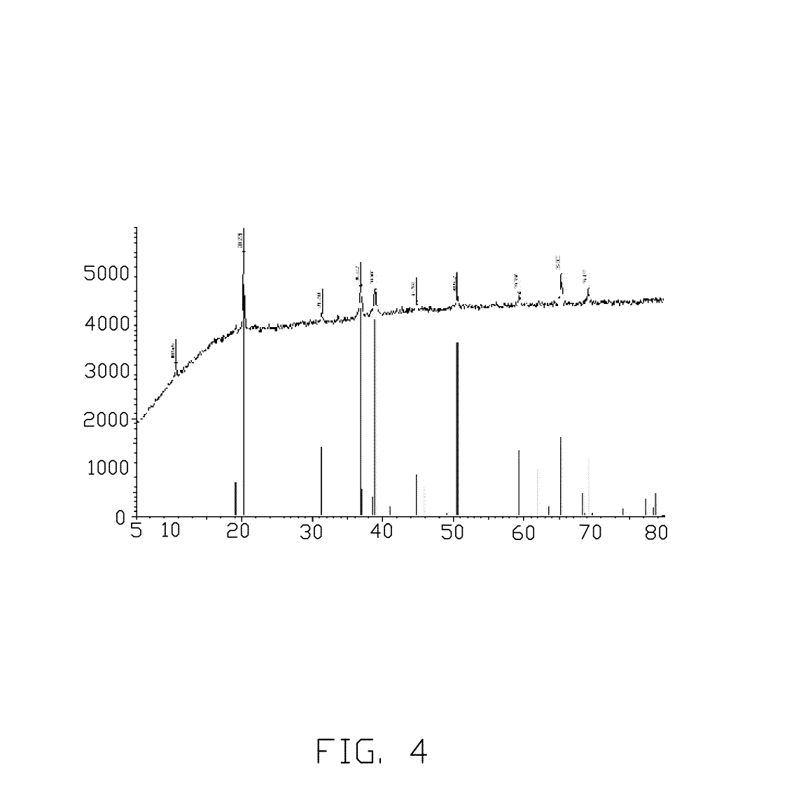

Referring to FIG. 4, XRD test is performed in relation to the spherical cobalt oxyhydroxide. The XRD pattern of the formed spherical cobalt oxyhydroxide is shown and compared with the standard pattern of cobalt oxyhydroxide shown at the bottom of FIG. 4, which indicates that the formed product is cobalt oxyhydroxide.

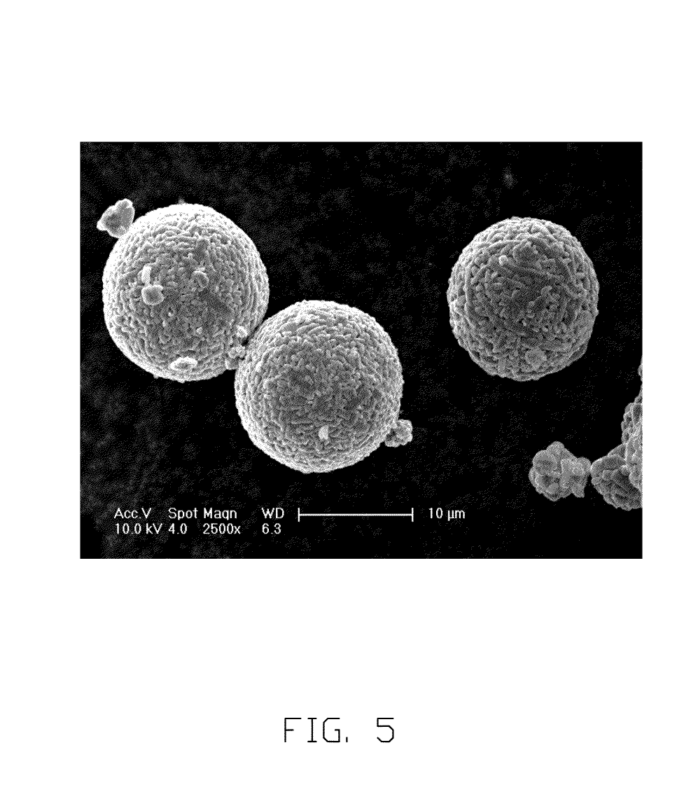

Referring to FIG. 5, for the reason that during the replacing of the hydrogen of the spherical cobalt oxyhydroxide with the lithium of the lithium hydroxide in the hydrothermal reaction, the spherical shape of the cobalt oxyhydroxide is maintained in the lithium cobalt oxide. Therefore, the lithium cobalt oxide also has a spherical shape, a dense structure, an ordered shape, and a high tap density.

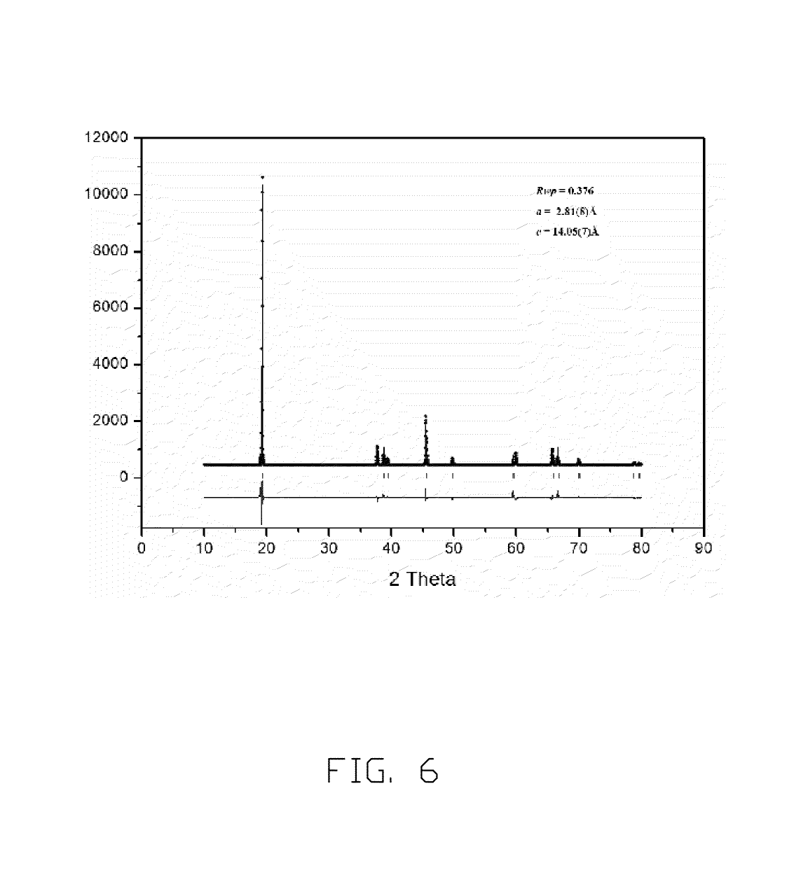

Referring to FIG. 6, XRD test is applied to the spherical lithium cobalt oxide. 2Theta in FIG. 6 represents the scanning degree, a and c are lattice parameters. By comparing with the standard pattern of lithium cobalt oxide as shown at bottom of the FIG. 6, the XRD pattern of the product can be identified as lithium cobalt oxide, which shows no impurity peaks, and has a relatively high peak strength indicating that the obtained lithium cobalt oxide has a relatively high crystallinity.

The present method uses a hydrothermal reaction to form the lithium cobalt oxide, having the entire synthesis take place in the liquid phase, by which the materials can be uniformly mixed at a low energy consumption, and the reacting solution can be recycled. The formed lithium cobalt oxide has the morphology of regular spheres. The spheres are obtained during the synthesis of the cobalt oxyhydroxide, and this morphology is maintained in all the following steps. The spheres have a controllable diameter and a high tap density. The spherical lithium cobalt oxide can have a diameter in a range from 5 μm to 20 μm, and a tap density in a range from 2.3 g·cm⁻³ to 2.9 g·cm⁻³.

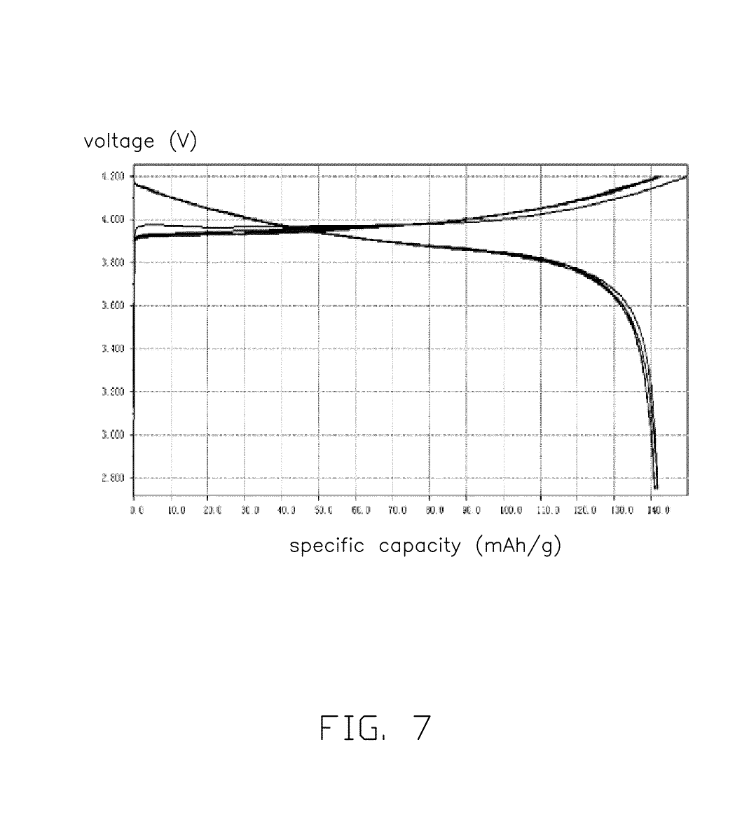

Referring to FIG. 7, a lithium ion battery is assembled using the obtained spherical lithium cobalt oxide as the cathode active material and lithium metal as the anode. The lithium ion battery is cycled and shows that the specific capacity is about 140 mAh/g with no significant decrease for the first 100 cycles. The spherical lithium cobalt oxide has a relatively high loose packed density and tap density, and a relatively small specific surface area. A surface modification to the micro-sized spheres can be more effective than that applied to nano-sized powder. Accordingly, a uniform, stable, dense, and firm surface coating on the spherical lithium cobalt oxide can be obtained. Further, the micro-sized spheres of the lithium cobalt oxide have a relatively good dispersing ability and mobility, beneficial for making the electrode plate of the lithium ion battery.

### Example 1

1) A controlled crystallization reactor having a volume of 4 L is used. 4 mol/L of ammonium hydroxide solution as the buffer agent is added into the controlled crystallization reactor, and mechanically stirred fast with a speed of 1500 rpm. 2 mol/L of cobalt chloride water solution and 4 mol/L of sodium hydroxide water solution are slowly added from two sides using the peristaltic pumps, with a flow rate of 0.5 mL/min, to form the spherical cobalt oxyhydroxide.

2) The spherical cobalt oxyhydroxide formed by 1) is washed several times by deionized water and pumped dry to remove the water.

3) 1 kg of spherical cobalt oxyhydroxide obtained by 2) is mixed with 400 g of saturated lithium hydroxide water solution and the mixture loaded into a high pressure hydrothermal reactor for the hydrothermal reaction. The hydrothermal reactor is heated to 150° C. and maintained for 5 hours at this temperature to obtain the spherical lithium cobalt oxide.

4) The spherical lithium cobalt oxide formed by 3) is taken out from the hydrothermal reactor and pumped dry.

5) The spherical lithium cobalt oxide obtained by 4) is dried at 50° C. for 10 hours.

6) The spherical lithium cobalt oxide obtained by 5) is introduced into the sintering oven, and sintered at 800° C. for 5 hours. The cathode active material of the lithium ion battery is thus formed.

### Example 2

1) A controlled crystallization reactor having a volume of 10 L is used. 8 mol/L of ammonium hydroxide solution as the buffer agent is added into the controlled crystallization reactor, and mechanically stirred fast with a speed of 900 rpm. 3 mol/L of cobalt chloride water solution and 6 mol/L of sodium hydroxide water solution are slowly added from two sides using the peristaltic pumps, with the flow rate of 2 mL/min, to form the spherical cobalt oxyhydroxide.

2) The spherical cobalt oxyhydroxide formed by 1) is washed several times by deionized water and pumped dry.

3) 3 kg of spherical cobalt oxyhydroxide obtained by 2) is mixed with 1 kg of saturated lithium hydroxide water solution and the mixture loaded into a high pressure hydrothermal reactor for the hydrothermal reaction. The hydrothermal reactor is heated to 200° C. and maintained for 1 hour at this temperature to obtain the spherical lithium cobalt oxide.

4) The spherical lithium cobalt oxide formed by 3) is taken out from the hydrothermal reactor and pumped dry.

5) The spherical lithium cobalt oxide obtained by 4) is dried at 90° C. for 5 hours.

6) The spherical lithium cobalt oxide obtained by 5) is introduced into the sintering oven and sintered at 350° C. for 10 hours. The cathode active material of the lithium ion battery is thus formed.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for making a spherical cobalt oxyhydroxide comprising:
providing a controlled crystallization reactor;
filling a buffer agent into the controlled crystallization reactor, wherein the buffer agent is capable of controlling a reacting speed of reactants;
adding a cobalt salt solution and an alkaline solution as reactants into the buffer agent in the controlled crystallization reactor;
reacting the reactants by using a controlled crystallization method while agitating the reactants only at a bottom region of a container of the controlled crystallization reactor.

2. The method of claim 1, wherein the bottom region is defined from the inner bottom of the container to a place having 1/10 to ⅓ depth of the container.

3. The method of claim 1, wherein the controlled crystallization reactor comprises the container, an agitating device, and a feeding device.

4. The method of claim 3, wherein the feeding device comprises a plurality of inlet tubes, the adding the cobalt salt solution and the alkaline solution is performed through respective inlet tubes.

5. The method of claim 3, the agitating device comprises a motor, a shaft, and at least one paddle, the shaft is connected to the motor, the at least one paddle is mounted only on an end of the shaft, the end of the shaft that has the at least one paddle mounted thereon is inserted into the container, and located in the bottom region in the container.

6. The method of claim 5, wherein the at least one paddle is located only in the bottom region in the container.

7. The method of claim 5, wherein the reacting the reactants by using the controlled crystallization method comprises rotating the at least one paddle, and a rotating speed of the at least one paddle is in a range from 900 rpm to 2000 rpm.

8. The method of claim 1, wherein at least ½ depth of the container is occupied by the reactants and the buffer agent.

9. The method of claim 1, wherein the cobalt salt solution is a water solution of a soluble cobalt salt, and the soluble cobalt salt is selected from the group consisting of cobalt chloride, cobalt sulfate, cobalt nitrate, and combinations thereof.

10. The method of claim 1, wherein the alkaline solution is selected from the group consisting of a water solution of potassium hydroxide, a water solution of sodium hydroxide, and a mixture thereof.

11. The method of claim 1, wherein a molar ratio between the cobalt salt and sodium hydroxide is about 12.

12. The method of claim 1, wherein in the adding the cobalt salt solution and the alkaline solution as the reactants into the buffer agent in the controlled crystallization reactor, a feeding amount per minutes of the reactants is in a range from 1/10000 to 1/300 of a volume of the container.

13. The method of claim 1, wherein the buffer agent is selected from the group consisting of ammonium hydroxide, ethylenediamine tetraacetic acid, lactic acid, and combinations thereof.

14. The method of claim 1, wherein the controlled crystallization reactor further comprises an overflow outlet located at an upper side of the container, when the spherical cobalt oxyhydroxide is thrown out the container from the overflow outlet.

15. The method of claim 14, wherein a diameter of the spherical cobalt oxyhydroxide is in a range from 5 μm to 20 μm.

16. The method of claim 14, wherein the adding of the cobalt salt solution and the alkaline solution and the agitating of the reactants in the controlled crystallization reactor are done at the same time and continuously performed, the spherical cobalt oxyhydroxide continuously overflows through the overflow outlet, and the cobalt salt solution and the alkaline solution are continuously added into the controlled crystallization reactor to maintain an amount of the reactants in the controlled crystallization reactor, thereby continuously forming the spherical cobalt oxyhydroxide.
